(19) United States
(12) Patent Application Publication
(10) Pub. No.: US 2022/0402788 A1
(43) Pub. Date: Dec. 22, 2022

(54) AERATOR WITH ADDITIVE INJECTOR FOR WASTEWATER PROCESSING

(71) Applicant: Triplepoint Environmental LLC, Centennial, CO (US)

(72) Inventors: Patrick D. HILL, Lone Tree, CO (US); Michael C. WEVER, Monticello, FL (US); Braden J. GALBREATH-O'LEARY, Denver, CO (US)

(73) Assignee: Triplepoint Environmental LLC, Centennial, CO (US)

(21) Appl. No.: 17/840,931

(22) Filed: Jun. 15, 2022

Related U.S. Application Data
(60) Provisional application No. 63/212,422, filed on Jun. 18, 2021.

(51) Int. Cl. C02F 1/74; C02F 1/68; B01F 23/231; B01F 23/237

(52) U.S. Cl. CPC C02F 1/74; C02F 1/685; B01F 23/2312; B01F 23/237611; B01F 2101/305

(57) ABSTRACT

An aerator for treating wastewater is configured to produce air bubbles to mix and circulate wastewater within a treatment facility. Additionally, the aerator is configured to inject additive into the wastewater at the same time as the air bubbles are being produced, so that roiling of the air bubbles and/or circulation induced by the air bubbles rising within the water column facilitates mixing of the additive with the wastewater.

### CROSS-REFERENCE TO RELATED APPLICATIONS

The present application is based on and claims the priority benefit of U.S. provisional application 63/212,422 filed Jun. 18, 2021, the contents of which are incorporated herein by reference.

### BACKGROUND AND FIELD OF THE INVENTION

The invention relates to processing of wastewater, e.g., in wastewater treatment lagoons.

In general, it is known to hold wastewater in one or more treatment lagoons as part of a wastewater treatment process. The wastewater may be aerated using submerged aeration devices, such as Ares® aerators available from Triplepoint Environmental LLC of Oak Park, Ill., which are distributed in an array across the bottom of the lagoon. Such aerators are illustrated and described, for example, in U.S. Pat. No. 11,097,229 issued Aug. 24, 2021, the contents of which are incorporated herein by reference.

Air is supplied to the aerators by means of one or more blowers that are installed near the lagoons, at surface level. A header pipe, which receives air from a blower, is typically buried underground and runs along the side of the lagoon(s). A riser pipe or stub lateral line, which extends up from the header pipe and is accessible above ground, is provided to deliver air to a given row of aerators in the array.

In some known arrangements, a manifold is located at the end of the riser pipe, and an airline extends from the manifold, down along the sides of the lagoon, and along the bottom of the lagoon to each submerged aerator. Alternatively, a group of airlines may be bundled together and floated/suspended at the surface of the lagoon, with a single airline “branching off” from the bundle and “dropping down” to supply air to an aerator at a given location. This latter arrangement may be as illustrated, for example, in U.S. Publication 2022/0041481 published Feb. 10, 2022, the contents of which are incorporated herein by reference.

In addition to aeration, it is known to supply various types of additives to the wastewater being treated. Such additives might include, for example, alum (to precipitate phosphorous out of the wastewater), hydrogen peroxide (to mitigate odors), bacterial sludge reducers, nitrifying bacteria (to lower ammonia), etc.

Furthermore, to keep a wastewater treatment lagoon operating efficiently, it is advisable to retrieve the aerators from the bottom of the lagoon for occasional cleaning and servicing.

### SUMMARY OF THE INVENTION

Embodiments of the inventive concept disclosed herein foster distribution of additives throughout a wastewater treatment lagoon. Additionally, they facilitate cleaning and servicing of the lagoon by keeping the arrangement of airlines and additive supply lines “neat and tidy,” thereby reducing entanglements when the aerators are retrieved for cleaning and servicing.

Thus, in one aspect, the invention features an aerator for treating wastewater. The aerator includes a bubble-producing member that defines a mixing chamber; an attachment point by which an airline can be connected to the aerator to supply air to the aerator; and an additive injector configured and arranged to introduce additive into the mixing chamber. The aerator is configured such that at least a first portion of air supplied to the aerator from the airline flows into the mixing chamber and out of the aerator, via the bubble-producing member, in the form of air bubbles. Co-introduction of air and additive into the mixing chamber facilitates mixing of the additive with wastewater.

In various embodiments, the bubble-producing member may be a coarse-bubble-producing member, and it may comprise a vertically extending tube with the mixing chamber being the interior region of the tube and with the additive injector being an injection quill extending into the mixing chamber. In one embodiment, the additive injector may be configured and arranged to introduce additive into the mixing chamber at a location above a point of introduction into the mixing chamber of the first portion of air supplied to the aerator.

The aerator may further include one or more fine-bubble-producing members that receive a second portion of air supplied to the aerator and that disseminate the second portion of air into the wastewater in the form of fine, fizz-type bubbles.

In another aspect, the invention features a method for treating wastewater. According to the method, air is introduced into the wastewater using an aerator, and additive is introduced into the wastewater using the aerator while air is being introduced into the wastewater via the aerator. Such co-introduction of air and additive into the wastewater facilitates mixing of the additive with the wastewater.

In one embodiment of the method, the aerator has a mixing chamber into which both the air and additive are introduced, with the air being introduced into the mixing chamber below a point at which the additive is introduced into the mixing chamber. With this embodiment, air bubbles rising within the mixing chamber pass through the additive as it is being introduced into the mixing chamber such that roiling motion of the air bubbles facilities mixing of the additive with the wastewater.

Alternatively, the air may be introduced into the mixing chamber above a point at which the additive is introduced into the mixing chamber. Assuming the mixing chamber has an open lower end as well as an open upper end through which the air bubbles out of the mixing chamber), wastewater will be drawn up into the mixing chamber through the open lower end thereof due to induced circulation, thereby facilitating mixing of the additive with the wastewater.

### BRIEF DESCRIPTION OF THE DRAWINGS

These concepts will be understood more fully from the following disclosure when read in conjunction with the Figures, in which:

FIG. 1 is a schematic diagram, partially broken away, of one embodiment of an aerator with additive injector in accordance with the claimed invention;

FIG. 1A is an enlarged view of the circled portion in FIG. 1; and

FIG. 2 is a schematic diagram of an alternative configuration of the aerator illustrated in FIG. 1

### DETAILED DESCRIPTION OF EMBODIMENTS OF THE INVENTION

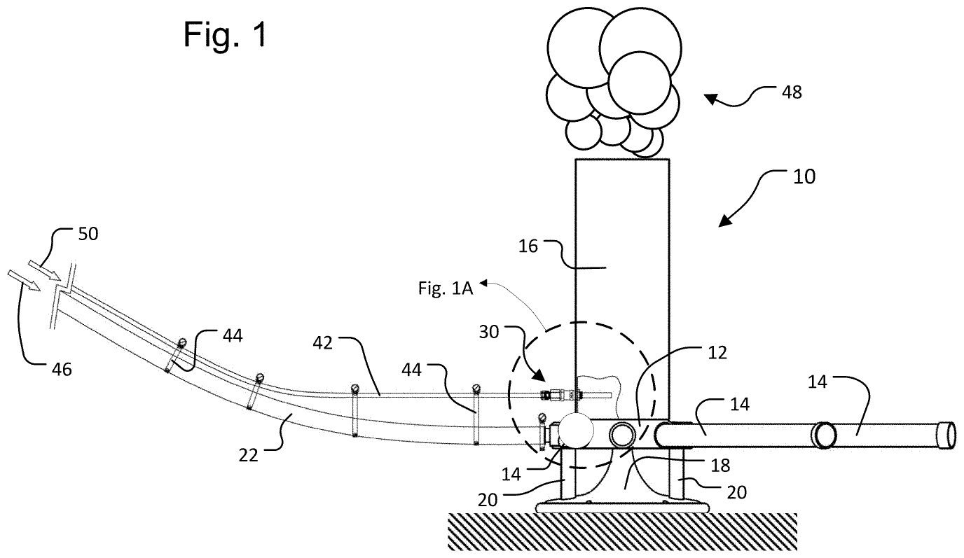

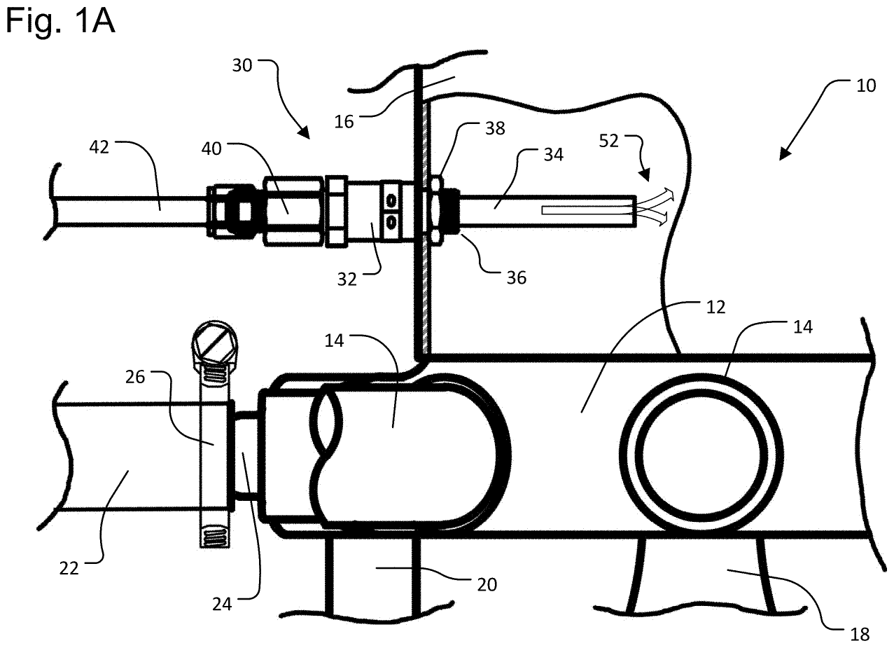

A first embodiment of an aerator with additive-injecting capability is illustrated in FIGS. 1 and 1A. As illustrated, the aerator 10 may be configured in large measure like one of the above-referenced Ares® aerators. Thus, the aerator 10 includes a ring-shaped hub 12, at least one (e.g., several, such as ten) fine-bubble-producing members 14 that extend outwardly from the hub 12; a central tube 16 (i.e., a coarse-bubble-producing member) that fits within and extends vertically from a central aperture (not illustrated explicitly) formed in the hub 12; and a weighted base assembly 18, which includes support legs 20. The central tube 16 is open at its upper end at least. An internal air chase (not illustrated) extends circumferentially around the ring-shaped hub 12 and receives air delivered to the aerator 10 via a surface-supplied airline 22. The airline 22 fits over an attachment point, e.g., hose barb 24, and can be secured in place via a stainless steel hose clamp 26. The ring-shaped hub 12 is constructed so that some of the air introduced into the internal air chase is ported into the central tube 16, where it forms coarse, roiling bubbles that rise from the central tube 16 into the water column as schematically illustrated to facilitate circulation and mixing of wastewater within the treatment lagoon. On the other hand, the rest of the air introduced into the internal air chase is ported into the fine-bubble-producing members 14, from which the air emanates through fine perforations along their surfaces (not illustrated) as fine, fizz-type bubbles (not illustrated) that optimize oxygenation of the wastewater in the treatment lagoon.

As further illustrated in FIGS. 1 and 1A, a stainless steel injection quill 30 is attached to the wall of the central tube 16 to inject additive into the interior of the central tube 16. In the illustrated embodiment 10, the injection quill 30 includes a body portion 32 with a conduit (not illustrated) extending through it, and a hollow tubular quill portion 34 extending from the body portion 32 into the interior of the central tube 16. A threaded portion 36, which has a smaller diameter than the body portion 32, passes through a hole (unlabeled) in the sidewall of the central tube 16, and the additive-injection quill 30 is secured to the central tube 16 using a stainless steel nut 38 screwed down onto the threaded portion 36 and into engagement with the inner surface of the central tube's sidewall. Alternatively, if the hole itself is threaded, the injection quill 30 may be screwed directly to the central tube 16. Suitably, the injection quill 30 includes an internal check valve, to prevent backflow of wastewater into the supply of additive.

The injection quill 30 has a hose fitting 40 at its opposite end, and a surface-supplied additive supply line 42 is attached to the injection quill 30 via the hose fitting 40. The hose fitting 40 may be of any type, such as the ferrule/compression nut-type (as illustrated); internal threading to receive and secure a hose barb; etc. As illustrated, the additive supply line 42 may be secured to the airline 22—preferably with a little bit of space or “play” between the two to facilitate bending and routing of the two lines—via stainless steel hose clamps 44.

Operation of the illustrated embodiment 10 is straightforward. During wastewater treatment, the aerator 10 is located on the bottom of a treatment lagoon, and air is supplied to the aerator 10 from a source (e.g., a surface-mounted blower) through the airline 22, as indicated schematically via arrow 46. Some of the air flows into the interior of the central tube 16 (i.e., a “mixing chamber” of sorts) and flows up and out from the central tube 16 as coarse, roiling bubbles 48. The rest of the air flows into the fine-bubble-producing members 14 and “fizzes” out of them in the form of fine bubbles (not illustrated).

At the same time (although not necessarily on a continuous basis), additive is supplied to the aerator 10, e.g., by being pumped from a supply tank (not illustrated) at the side of the treatment lagoon as indicated schematically via arrow 50. The additive is injected into the “mixing chamber” formed by the interior of the central tube 16, as illustrated schematically via arrows 52. In the illustrated embodiment, the additive is injected into the interior of the central tube 16 at a location above the point of introducing air into the interior of the central tube 16, and this relative positioning of the points of introduction ensures good mixing of the additive with the water being treated given the roiling, turbulent nature of the air-bubbling. Alternatively—especially if the central tube 16 is open at its lower end as well as its upper end—the additive could be introduced into the interior of the central tube 16 below the point of introducing the air given that as the air bubbles rise within the central tube 16, circulation is induced that pulls water up into the central tube 16 from below, and this induced circulation also facilitates mixing of the additive with the water being treated.

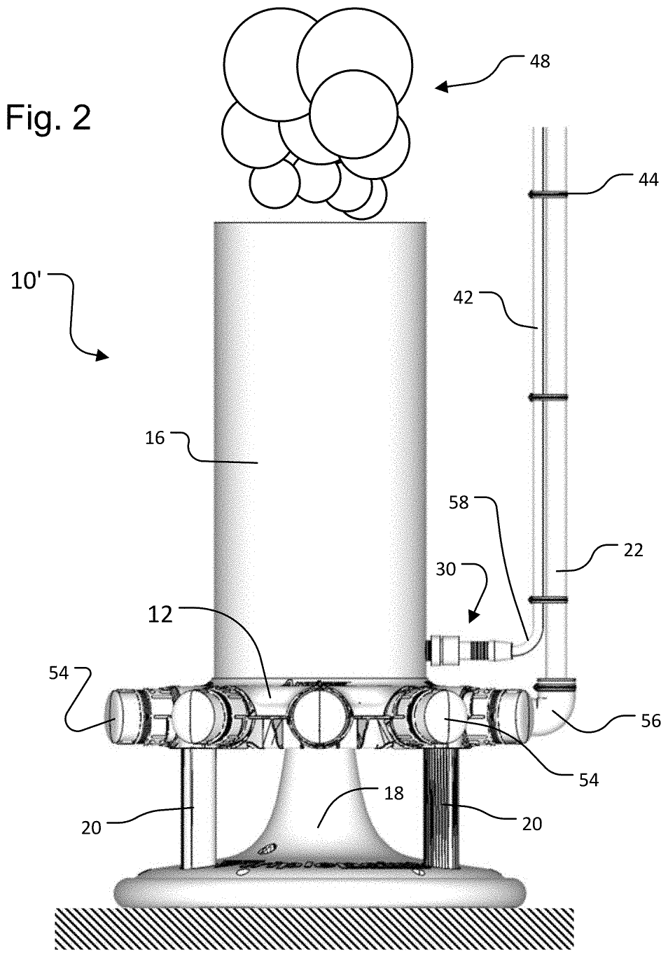

In the first embodiment of an aerator illustrated in FIGS. 1 and 1A, the aerator 10 includes multiple fine-bubble-producing members 14 extending from the central, ring-shaped hub 12. As explained in U.S. Pat. No. 11,097,229 referenced above, the fine-bubble-producing members may be removably attached to the ring-shaped hub 12, e.g., via a threaded connection or via a quarter-turn-to-lock, quick-connect fitting. Therefore, for wastewater treatment facilities where space is limited and oxygenation is not (significantly) required, the fine-bubble-producing members 14 could be eliminated and the ports (not illustrated) through which air flows from the internal air chase in the ring-shaped hub 12 into the fine-bubble-producing members could be closed off using caps or plugs 54, as shown in the embodiment 10′ illustrated in FIG. 2. To help keep the aeration arrangement compact, an elbow fitting 56 could be provided to connect the airline 22 to the aerator 10′, thereby enabling the airline 22 to extend straight up to the surface of the wastewater treatment facility as illustrated in U.S. Publication 2022/0041481. Additionally, depending on the nature of the additive supply line 42 (i.e., whether it tends to crimp or not), the additive supply line 42 could simply be bent, as illustrated at curve 58, or, alternatively, it could be connected to the injection quill 30 via an elbow fitting (not illustrated). Construction, arrangement, and operation of the embodiment 10′ is otherwise the same as described above for the embodiment 10.

Various modifications to and departures from the disclosed embodiment will occur to those having skill in the art. The scope of the invention is defined by the following claims.

What is claimed is:

1. An aerator for treating wastewater, comprising:
a bubble-producing member that defines a mixing chamber;
an attachment point by which an airline can be connected to the aerator to supply air to the aerator, the aerator being configured such that at least a first portion of air supplied to the aerator from the airline flows into the mixing chamber and out of the aerator, via the bubble-producing member, in the form of bubbles; and
an additive injector configured and arranged to introduce additive into the mixing chamber defined by the bubble-producing member.

2. The aerator of claim 1, wherein the bubble-producing member produces coarse air bubbles.

3. The aerator of claim 1, wherein the bubble-producing member comprises a vertically extending tube and the mixing chamber comprises an interior region of the vertically extending tube.

4. The aerator of claim 1, wherein the additive injector comprises an injection quill extending into the mixing chamber.

5. The aerator of claim 1, wherein the additive injector is configured and arranged to introduce additive into the mixing chamber at a location above a point of introduction into the mixing chamber of the first portion of air supplied to the aerator.

6. The aerator of claim 1, further comprising at least one fine-bubble-producing member configured and arranged to receive a second portion of air supplied to the aerator via the airline and to disseminate the second portion of air supplied to the aerator into water being treated in the form of fine, fizz-type bubbles.

7. A method for treating wastewater, comprising:
introducing air into the wastewater using an aerator;
introducing additive into the wastewater using the aerator while air is being introduced into the wastewater via the aerator such that the aerator facilitates mixing of the additive with the wastewater.

8. The method of claim 7, wherein
the aerator has a mixing chamber that is open at an upper end thereof;
the air is introduced into the mixing chamber before being released into the wastewater through the open upper end of the mixing chamber; and
the additive is introduced into the mixing chamber above a point of introduction of the air into the mixing chamber;
whereby air bubbles rising within the mixing chamber pass through the additive as it is being introduced into the mixing chamber such that roiling motion of the air bubbles facilities mixing of the additive with the wastewater.

9. The method of claim 7, wherein
the aerator has a mixing chamber that is open at upper and lower ends thereof;
the air is introduced into the mixing chamber before being released into the wastewater through the open upper end of the mixing chamber; and
the additive is introduced into the mixing chamber below a point of introduction of the air into the mixing chamber;
whereby air bubbles rising within the mixing chamber and out of the aerator through the open upper end thereof cause wastewater to be drawn up into the mixing chamber through the open lower end thereof, thereby facilitating mixing of the additive with the wastewater.
